(19) United States
(12) Patent Application Publication
(10) Pub. No.: US 2019/0140220 A1
(43) Pub. Date: May 9, 2019

(54) BATTERY WITH ELECTRICALLY INSULATING CONTAINER

(71) Applicant: Pacesetter, Inc., Santa Clara, CA (US)

(72) Inventor: Xiaofei Jiang, Clemson, SC (US)

(21) Appl. No.: 16/183,526

(22) Filed: Nov. 7, 2018

Related U.S. Application Data
(60) Provisional application No. 62/582,475, filed on Nov. 7, 2017.
(60) Provisional application No. 62/734,839, filed on Sep. 21, 2018.
(60) Provisional application No. 62/750,075, filed on Oct. 24, 2018.

(51) Int. Cl. H01M 2/02; H01M 2/08; H01M 2/06; H01M 2/04

(52) U.S. Cl. CPC H01M 2/028; H01M 2/0217; H01M 2220/30; H01M 2/06; H01M 2/0404; H01M 2/08

(57) ABSTRACT

The battery includes an electrode assembly in an interior of an electrically insulating container. The electrode assembly includes one or more first electrodes alternated with one or more second electrodes. The container is positioned in an interior of an electrically conducting battery case. The container being is constructed such that the battery case is not in electrical communication with the one or more first electrodes and the one or more second electrodes, and such that an electrolyte positioned in an interior of the container does not contact the battery case.

### RELATED APPLICATIONS

This Application claims the benefit of U.S. Provisional Patent Application Ser. No. 62/582,475 and filed on Nov. 7, 2017; and also of U.S. Provisional Patent Application Ser. No. 62/734,839 and filed on Sep. 21, 2018; and also of U.S. Provisional Patent Application Ser. No. 62/750,075 and filed on Oct. 24, 2018; each of which is incorporated herein in its entirety.

### FIELD

The invention relates to electrochemical devices. In particular, the invention relates to batteries.

### BACKGROUND

Batteries are commonplace in a wide variety of electrical applications. Improvements in battery life and failure rate are constantly being sought in order to achieve better longevity and performance. This is particularly true in implantable medical devices (IMDs), such as implantable cardiac monitors (ICMs), where a long-lasting, failure free battery is critical.

Batteries used in implantable devices typically include an outer case formed from electrically conductive materials. Additionally, these batteries are typically configured to operate with the case functioning as a negative or positive terminal. In some IMD applications, the battery case may be used as a sensing electrode. In these instances, it is desirable that the battery has a design in which the battery case is electrically isolated from the components of an electrode assembly within the battery case. For instance, it is often desirable for the battery case to be electrically isolated from the positive electrode(s), the negatives electrode(s) and the associated electrolyte.

The manufacture of a battery device having an electrically isolated case has proven be difficult because the electrolyte is normally in contact with the case. As a result, there is a need for an improved battery having an outer case electrically isolated from the electrically conductive components of an electrode assembly.

### SUMMARY

A battery includes an electrode assembly in an interior of an electrically insulating container. The electrode assembly includes one or more first electrodes alternated with one or more second electrodes. The container is positioned in an interior of an electrically conducting battery case. The container being is constructed such that the battery case is not in electrical communication with the one or more first electrodes and the one or more second electrodes, and such that an electrolyte positioned in an interior of the container does not contact the battery case.

In some instances, a battery is made by fabricating an electrically insulating container that includes an electrode assembly in an interior of the container. The electrode assembly includes one or more first electrodes alternated with one or more second electrodes. Making the battery also includes fabricating an electrically conducting battery case that includes the container in an interior of the battery case without the one or more first electrodes and the one or more second electrodes being in electrical communication with the battery case.

### BRIEF DESCRIPTION OF THE FIGURES

FIG. 1A through FIG. 1C illustrate the relationship between multiple components of a battery. FIG. 1A is a perspective view of battery components including a header, an electrode assembly, and an assembly housing.

FIG. 1B is a cross section of the header shown in FIG. 1A taken along the line labeled A in FIG. 1A.

FIG. 1C is a bottomview of the header shown in FIG. 1A taken looking in the direction of the arrow labeled C in FIG. 1B.

FIG. 1D is a perspective view of a battery precursor that results from assembly of the components shown in FIG. 1A.

FIG. 1E is a cross section of the battery precursor of FIG. 1D taken through an interface between the housing and the header.

FIG. 1F is a sideview of the cross section the battery precursor of FIG. 1D taken along the line labeled F in FIG. 1D. The cross section of FIG. 1F is taken in the direction of the arrow labeled G in FIG. 1F.

FIG. 2A through FIG. 2F illustrate the relationship between multiple components of another embodiment of a battery precursor. FIG. 2A is a perspective view of battery components including the header, the electrode assembly, and the assembly housing.

FIG. 2B is a cross section of the header 10 shown in FIG. 2A taken along the line labeled A in FIG. 2A.

FIG. 2C is a bottomview of the header shown in FIG. 1A taken looking in the direction of the arrow labeled C in FIG. 2B.

FIG. 2D is an exploded view of the header shown in FIG. 2A through FIG. 2C.

FIG. 2E is perspective view of a battery precursor that results from assembly of the components shown in FIG. 2A.

FIG. 2F is a cross section of the battery precursor of FIG. 2E taken through an interface between the housing and the header.

FIG. 2G is a sideview of the cross section the battery precursor of FIG. 2F taken along the line labeled F in FIG. 2E. The cross section of FIG. 2G is treated as a sideview taken looking in the direction of the arrow labeled G in FIG. 2E.

FIG. 3A through FIG. 3D illustrate a weld system that includes a battery precursor, a laser source, and a weld tool. FIG. 3A is a perspective view of the weld system.

FIG. 3B is a cross section of the weld system of FIG. 3A taken at an interface between the battery precursor and the weld tool.

FIG. 3C is a schematic illustration of the laser source and the weld tool.

FIG. 3D is a sideview of the laser tool shown in FIG. 3C taken looking in the direction of the arrow labeled D in FIG. 3C.

FIG. 3E is a sideview of another embodiment of the laser tool shown in FIG. 3C taken looking in the direction of the arrow labeled D in FIG. 3C.

FIG. 4A through FIG. 4C illustrate an example of a weld system where a chuck for holding the battery precursor is independent of the mechanism for applying a laser signal. FIG. 4A is a perspective view of a cross section of a chuck.

FIG. 4B is a sideview of the chuck shown in FIG. 4A taken looking in the direction of the arrow labeled B in FIG. 4A. The cross section of FIG. 4A is taken along the line labeled A in FIG. 4B.

FIG. 4C illustrates a weld system where a laser source applies a laser signal to a battery precursor held by the chuck of FIG. 4A and FIG. 4B. In FIG. 4C, a cross section of the battery precursor and chuck are shown.

FIG. 5 illustrates a weld system according to FIG. 4A through FIG. 4C where at least a portion of the chuck is configured to transmit a laser signal.

FIG. 6A through FIG. 6C illustrate assembly of a battery from the battery precursor of FIG. 1A through FIG. 1F. FIG. 6A is an exploded view of the battery.

FIG. 6B is a perspective view of the battery.

FIG. 6C is a cross section of the battery.

FIG. 6D is a cross section of a battery constructed according to FIG. 6A through FIG. 6C but with the battery precursor of FIG. 2A through FIG. 2G.

FIG. 7A through FIG. 7C illustrate assembly of a battery from the battery precursor of FIG. 2A through FIG. 2G. FIG. 7A is an exploded view of the battery.

FIG. 7B is a perspective view of the battery.

FIG. 7C is a cross section of the battery.

FIG. 7D is a cross section of a battery constructed according to FIG. 7A through FIG. 7C but with the battery precursor of FIG. 1A through FIG. 1F.

FIG. 8 is a perspective view of one example of a suitable housing for use in the battery.

FIG. 9 is a perspective view of an example of a suitable electrode assembly for use in the battery.

FIG. 10A through FIG. 10D illustrate a heat-sealing system suitable for creating a heat seal at an interface between a sealing member and an engagement portion of a housing. FIG. 10A is a perspective view of the heat-sealing system.

FIG. 10B is a topview of the heat-sealing system of FIG. 10A. The heat-sealing system includes a battery precursor between heating elements.

FIG. 10C is a topview of the heat-sealing system of FIG. 10B after a first portion of the heating elements have been moved into contact with the battery precursor.

FIG. 10D is a topview of the heat-sealing system of FIG. 10C after a second portion of the heating elements have been moved into contact with the battery precursor.

FIG. 11 illustrates an example of a battery header that includes a cover member overmolded with a plastic sealing member.

FIG. 12 illustrates an example of an electrically insulating housing configured to hold an electrode assembly.

FIG. 13 illustrates an example of an electrode assembly electrically connected to the header of FIG. 11.

FIG. 14 illustrates the electrode assembly of FIG. 11 positioned in an interior of the housing of FIG. 12 with the housing sealed to the sealing member.

FIG. 15 illustrates a finished case neutral battery.

### DESCRIPTION

A battery includes an electrode assembly in an interior of an electrically insulating container. The electrode assembly includes one or more first electrodes alternated with one or more second electrodes. The container is positioned in an interior of an electrically conducting battery case. The container being is constructed such that the battery case is not in electrical communication with the one or more first electrodes and the one or more second electrodes, and such that an electrolyte positioned in an interior of the container does not contact the battery case. As a result, the battery has an outer case that is electrically isolated from the electrically conductive components of the electrode assembly.

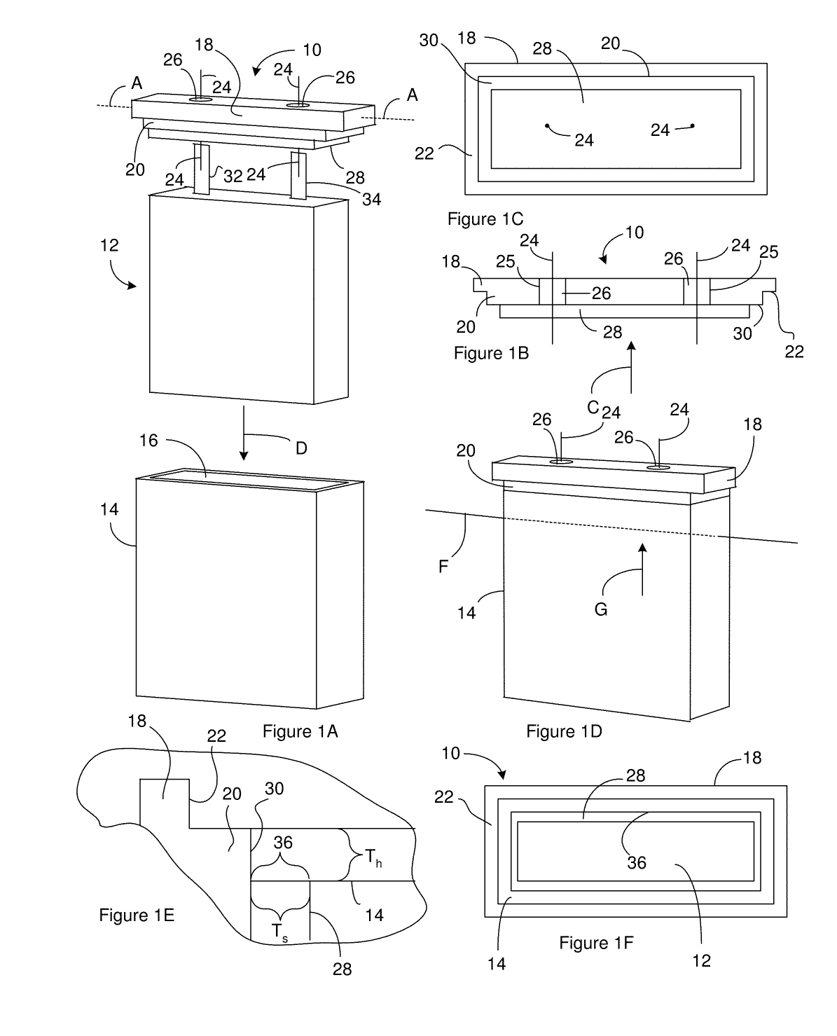

FIG. 1A through FIG. 1F illustrate the relationship between multiple components of a battery precursor. FIG. 1A is a perspective view of battery components including a header 10, an electrode assembly 12, and an assembly housing 14. FIG. 1B is a cross section of the header 10 shown in FIG. 1A taken along the line labeled A in FIG. 1A. FIG. 1C is a bottomview of the header 10 shown in FIG. 1A taken looking in the direction of the arrow labeled C in FIG. 1B. FIG. 1D is a perspective view of a battery precursor that results from assembly of the components shown in FIG. 1A. FIG. 1E is a cross section of the battery precursor of FIG. 1D taken through an interface between the housing 14 and the header 10. FIG. 1F is a sideview of the cross section the battery precursor of FIG. 1D taken along the line labeled F in FIG. 1D. The cross section of FIG. 1F is treated as a sideview taken looking in the direction of the arrow labeled G in FIG. 1D. As a result, components in the background of the plane of the cross section are shown in FIG. 1F.

The housing 14 includes an opening 16 that extends into an interior of the housing 14. The housing 14 includes, consists of, or consists essentially of an electrically insulating material. In some instances, the opening 16 extends into the electrically insulating material. Suitable electrically insulating material materials for the housing 14 include, but are not limited to, thermoplastics, Ethylene TetraFluoroEthylene (ETFE), Fluorinated Ethylene Propylene (FEP) and plastics and/or polymers such as polyethylene (PE), Polypropylene (PP), PolyEther Ether Ketone (PEEK).

The header 10 includes a cover member with an upper region 18 and a lower region 20. The upper region 18 extends beyond the perimeter of the lower region 20 such that a cover step is formed at an edge of the cover member. In some instances, the cover step surrounds an interior of the cover member. For instance, the lower region 20 can fall within the perimeter of the upper region 18 as is most evident from FIG. 1C. The portion of the upper region 18 that remains exposed can serve as an engagement shelf 22 that engages a battery case. Although the cover member is illustrated as a single material, the cover member can be constructed of multiple layers of material. Suitable materials for the cover member include, but are not limited to, titanium, stainless steel, and aluminum.

The header 10 includes feedthrough pins 24 that extend through openings 25 in the cover member. The feedthrough pins 24 can serve as battery terminals that are accessibly from outside of the battery. The feedthrough pins 24 can be immobilized within the openings by an electrically insulating sealing medium 26 such as is used in a Glass-To-Metal Seal (GTMS). Suitable sealing media include, but are not limited to, ceramics, glass, and quartz. Suitable feedthrough pins 24 include, but are not limited to, molybdenum, titanium, and niobium.

The header 10 includes a sealing member 28. The lower region 20 of the header 10 extends beyond the perimeter of the sealing member 28 such that a housing step is formed at an edge of the header 10. In some instances, the housing step surrounds an interior of the header 10. For instance, the footprint of the sealing member 28 can fall within the perimeter of the lower region 20 as is most evident from FIG. 1C. The portion of the lower region 20 that remains exposed can serve as a housing shelf 30 that engages the housing 14.

The electrode assembly 12 includes multiple electrodes (not shown) and one or more separators (not shown). The electrodes include one or more first electrodes (not shown) and one or more second electrodes (not shown). The first electrodes can each be an anode or a negative electrode and the second electrodes can each be a cathode or a positive electrode. The electrodes are arranged such that first electrodes are alternated with second electrodes and a separator is positioned between neighboring electrodes. The electrodes in the electrode assembly 12 can be in a stacked, wound or rolled arrangement such as a jelly-roll configuration. Although not illustrated, a battery electrolyte can contact the electrodes included in the electrode assembly. The electrolyte can be a solid, liquid, or gel.

The electrode assembly 12 also includes electrical conductors that include one or more first conductors 32 and one or more second conductors 34. The conductors provide electrical communication between the electrodes and the feedthrough pins 24. For instance, as shown in FIG. 1A, the one or more first conductors can be in electrical communication with the one or more first electrodes and with one of the feedthrough pins 24 while the one or more second conductors are in electrical communication with the other feedthrough pin 24 and with the one or more second electrodes. Suitable conductors include, but are limited to tabs, wires, foil, and mesh. Suitable methods for providing electrical communication between the conductors and the feedthrough pins 24 include, but are not limited to, welding such as resistance welding, laser welding, and ultrasonic welding.

The battery precursor of FIG. 1D can be formed by inserting the electrode assembly 12 into the opening in the housing 14 as illustrated by the arrow labeled D in FIG. 1A. The insertion of the electrode assembly 12 into the housing 14 can continue until the housing shelf 30 engages the upper edge of the housing 14 as is shown in FIG. 1E. An interface 36 is formed between the housing 14 and a lateral side of the sealing member 28. The interface 36 can surround the sealing member 28 as is evident from FIG. 1F.

FIG. 1F assumes that the electrode assembly 12 is spaced apart from the housing 14. As a result, the sealing member 28 is visible in the background of the cross section of FIG. 1F. However, the electrode assembly 12 can be in contact with the housing 14. For instance, one or more electrodes and/or a separator included in the electrode assembly 12 can contact the housing 14. In an example where the electrode assembly 12 contacts the housing 14, the zone where the electrode assembly 12 contacts the housing 14 surrounds at least a portion of the electrode assembly.

The thickness of the portion of the housing 14 in the interface 36 with the sealing member 28 (the engagement portion of the housing 14) is labeled Tₕ in FIG. 1E. A suitable thickness for the engagement portion of the housing 14 (Tₕ) is greater than 0.0005″, 0.004″, or 0.008″ and/or less than 0.01″, 0.03″. or 0.1″. In some instances, the engagement portion of the housing 14 or the entire housing 14 is constructed of a single continuous layer of the electrically insulating material. Suitable electrically insulating materials include, but are not limited to, thermoplastics, Ethylene TetraFluoroEthylene (ETFE), Fluorinated Ethylene Propylene (FEP) and plastics and/or polymers such as polyethylene (PE), Polypropylene (PP), PolyEther Ether Ketone (PEEK).

The length of the portion of the sealing member 28 interfaced with the housing 14 is labeled Tₛ in FIG. 1E. A suitable thickness for Tₛ is greater than 0.004″, 0.008″, or 0.012″ and/or less than 0.04″, or 0.1″. In some instances, the sealing member 28 is constructed of a single, continuous layer of material. Accordingly, the portion of the sealing member 28 that includes the surface(s) interfaced with the housing 14 can be a single, continuous layer of electrically insulating material. Suitable electrically insulating materials include, but are not limited to, Ethylene TetraFluoroEthylene (ETFE), Fluorinated Ethylene Propylene (FEP) and plastics and/or polymers such as polyethylene (PE), Polypropylene (PP), PolyEther Ether Ketone (PEEK). In some instances, the material for the portion of the sealing member 28 that includes the surface(s) interfaced with the housing 14 is the same as the material of the engagement portion of the housing 14. In some instances, the material for the portion of the sealing member 28 that includes the surface(s) interfaced with the housing 14 are different from the material for the engagement portion of the housing 14. In one example, the sealing member 28 and the housing 14 are constructed of the same materials. In some instances, the sealing member 28 and the housing 14 are constructed of different materials. When the sealing member 28 and the housing 14 are constructed of different materials, the sealing member 28 and the housing 14 can have similar melting temperatures in order to permit bonding of the materials by technologies such as welding and heat sealing. For instance, the melting temperature of the sealing member 28 can be greater than 90% or 100% and/or less than 110%, 120%, or 140% of the melting temperature of the housing 14.

The housing 14 and the sealing member 28 are bonded so as to form a sealed reservoir in which the electrode assembly 12 is positioned. Suitable mechanisms for bonding the housing 14 and sealing member 28 include, but are not limited to, heat sealing and welding such as ultra-sonic welding and laser welding. The laser welding can be performed under weld purge conditions. A suitable atmosphere for the weld purge conditions includes, but is not limited to, argon and nitrogen.

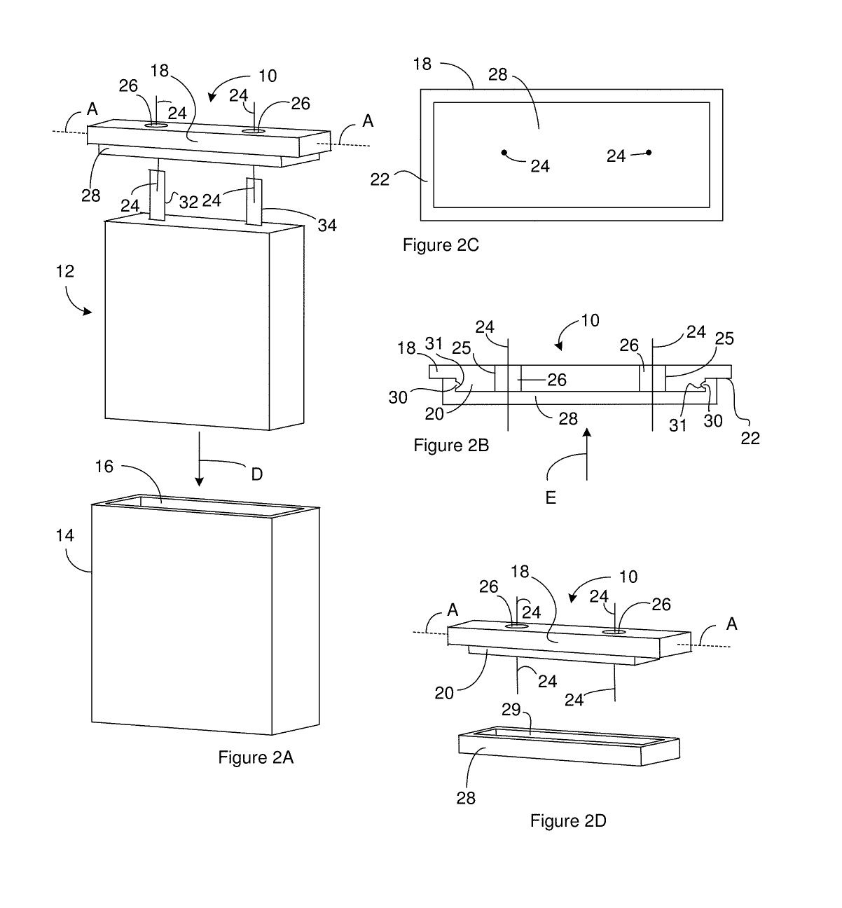

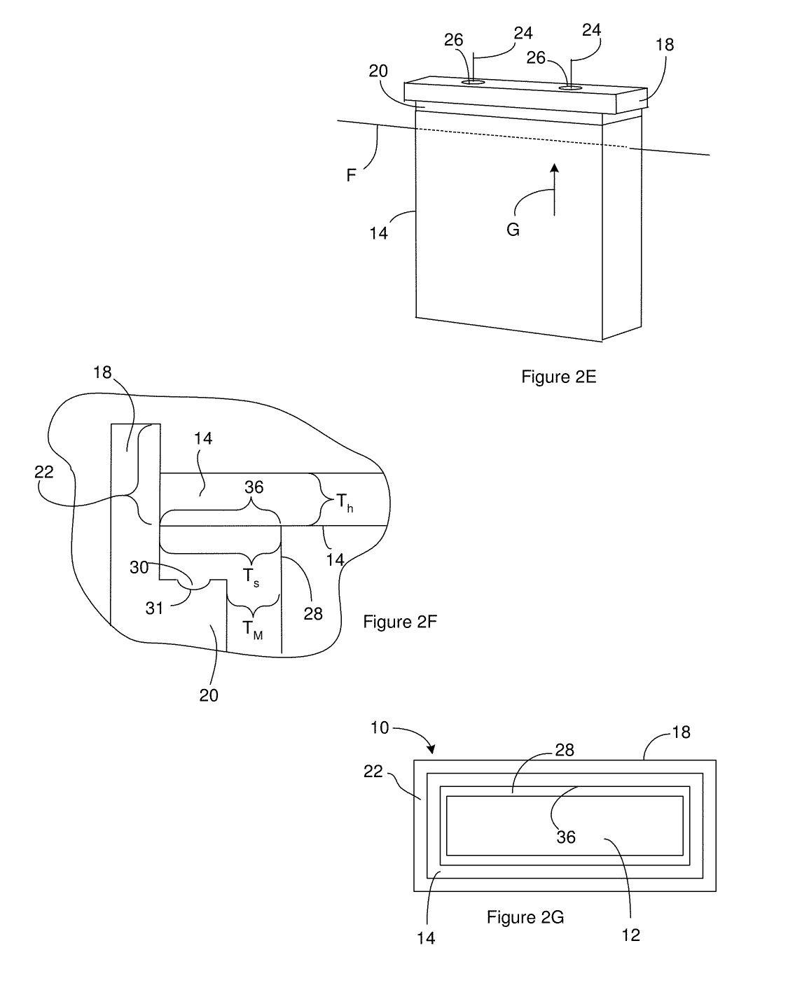

FIG. 2A through FIG. 2F illustrate the relationship between multiple components of another embodiment of a battery precursor. FIG. 2A is a perspective view of battery components including the header 10, the electrode assembly 12, and the assembly housing 14. FIG. 2B is a cross section of the header 10 shown in FIG. 2A taken along the line labeled A in FIG. 2A. FIG. 2C is a bottomview of the header 10 shown in FIG. 1A taken looking in the direction of the arrow labeled C in FIG. 2B. FIG. 2D is an exploded view of the header 10 shown in FIG. 2A through FIG. 2C. FIG. 2E is perspective view of a battery precursor that results from assembly of the components shown in FIG. 2A. FIG. 2F is a cross section of the battery precursor of FIG. 2E taken through an interface between the housing 14 and the header 10. FIG. 2G is a sideview of the cross section the battery precursor of FIG. 2F taken along the line labeled F in FIG. 2E. The cross section of FIG. 2G is treated as a sideview taken looking in the direction of the arrow labeled G in FIG. 2E. As a result, components in the background of the cross section plane are shown in FIG. 2G.

The housing 14 includes an opening 16 that extends into an interior of the housing 14. The housing 14 includes, consists of, or consists essentially of an electrically insulating material. In some instances, the opening 16 extends into the electrically insulating material. Suitable electrically insulating material materials for the housing 14 include, but are not limited to, Ethylene TetraFluoroEthylene (ETFE), Fluorinated Ethylene Propylene (FEP) and plastics and/or polymers such as polyethylene (PE), Polypropylene (PP), PolyEther Ether Ketone (PEEK).

The header 10 includes a cover member with an upper region 18 and a lower region 20. The upper region 18 extends beyond the perimeter of the lower region 20 such that a cover step is formed at an edge of the cover member. In some instances, the cover step surrounds an interior of the cover member. For instance, the lower region 20 can fall within the perimeter of the upper region 18 as is most evident from FIG. 1C. Although the cover member is illustrated as a single material, the cover member can be constructed of multiple layers of material. Suitable materials for the cover member include, but are not limited to, titanium, stainless steel, and aluminum.

The header 10 includes feedthrough pins 24 that extend through openings 25 in the cover member. The feedthrough pins 24 can be immobilized within the openings by an electrically insulating sealing medium 26 such as is used in a Glass-To-Metal Seal (GTMS). Suitable sealing media include, but are not limited to, ceramics, glass, and quartz. Suitable feedthrough pins 24 include, but are not limited to, molybdenum, titanium, and niobium.

The header 10 includes a sealing member 28. A recess 29 extends into the sealing member 28 such that the recess has internal laterals walls extending from a bottom. The recess 29 is sized to receive the lower region 20 of the cover member with at least a portion of the height of the lateral wall surrounding the lower region 20 of the cover member. The recess 29 can be sized such that the sealing member 28 covers only a portion or all of the lateral sides of the lower region 20 of the cover member. For instance, FIG. 2B illustrates the recess 29 sized such that the sealing member 28 covers the entire height of the lateral sides of the lower region 20 of the cover member. The lateral walls of the sealing member 28 can contact the lateral sides of the lower region 20 of the cover member. A zone of contact between the lateral walls of the sealing member 28 and the lateral sides of the lower region 20 of the cover member can surround the lower region 20 of the cover member.

In some instances, the sealing member 28 is attached to the lower region 20 of the cover member by a press fit and/or an interference fit. As an example, in some instances, the lateral sides of the lower region 20 include one or more projections that are each complementary to a recess on lateral walls of the sealing member 28 and/or the lateral sides of the lower region 20 include one or more recesses that are each complementary to a projection on lateral walls of the sealing member 28. Each of the projections can be received in one of the recesses. For instance, FIG. 2B and FIG. 2F illustrates a projection 30 from the lateral walls of the sealing member 28 received in a recess 31 on the lateral sides of the lower region 20. One or more of the recesses and/or one or more of the projections can surround the lower region 20 of the cover member. For instance, an interface between the one or more recesses and the projections can surround the lower region 20 of the cover member.

At least a portion of the upper region 18 extends beyond the perimeter of the lower region 20 and the sealing member 28 such that a cover step is formed at an edge of the cover member. In some instances, the cover step surrounds an interior of the cover member. For instance, the lower region 20 can fall within the perimeter of the upper region 18 as is most evident from FIG. 2B. The portion of the upper region 18 that remains exposed beyond the sealing member 28 can serve as the engagement shelf 22 that can engage a battery case and/or the housing 14. Although the cover member is illustrated as a single material, the cover member can be constructed of multiple layers of material. Suitable materials for the cover member include, but are not limited to, titanium, stainless steel, and aluminum.

In some instances, the sealing member 28 contacts the feedthrough pins 24 and is sealed to the feedthrough pins 24. As a result, electrolyte in contact with the sealing member 28 does not contact the cover member through the sealing member 28. In some instances, the sealing member 28 is constructed such that electrolyte in contact with the sealing member 28 contacts the sealing medium 26 without contacting the cover member. Accordingly, the cover member does not contact the electrolyte. In some instances, the sealing member is immobilized on the cover member in that the portion of the sealing member contacting the cover member is not free to move away from the cover member. Suitable methods for attaching the sealing member 28 to the cover assembly include, but are not limited to, overmolding, injection molding, and vacuum forming.

The battery precursor of FIG. 2E can be formed by inserting the electrode assembly 12 into the opening in the housing 14 as illustrated by the arrow labeled D in FIG. 2A. The insertion of the electrode assembly 12 into the housing 14 can continue until the engagement shelf 22 engages the upper edge of the housing 14 as is shown in FIG. 2F. The interface 36 is formed between the housing 14 and a lateral side of the sealing member 28. The interface 36 can surround the sealing member 28 as is evident from FIG. 2G.

FIG. 2G assumes that the electrode assembly 12 is spaced apart from the housing 14. As a result, the sealing member 28 is visible in the background of the cross section of FIG. 1F. However, the electrode assembly 12 can be in contact with the housing 14. For instance, one or more electrodes and/or a separator included in the electrode assembly 12 can contact the housing 14. In an example where the electrode assembly 12 contacts the housing 14, the zone where the electrode assembly 12 contacts the housing 14 surrounds at least a portion of the electrode assembly.

The thickness of the portion of the housing 14 in the interface 36 with the sealing member 28 (the engagement portion of the housing 14) is labeled Tₕ in FIG. 1E. A suitable thickness for the engagement portion of the housing 14 (Tₕ) is greater than 0.0005″, 0.004″, or 0.008″ and/or less than 0.01″, 0.03″, or 0.1″. In some instances, the engagement portion of the housing 14 or the entire housing 14 is constructed of a single continuous layer of the electrically insulating material. Suitable electrically insulating materials include, but are not limited to, Ethylene TetraFluoroEthylene (ETFE), Fluorinated Ethylene Propylene (FEP) and plastics and/or polymers such as polyethylene (PE), Polypropylene (PP), PolyEther Ether Ketone (PEEK).

The length of the portion of the sealing member 28 interfaced with the housing 14 is labeled Tₛ in FIG. 2F. A suitable thickness for Tₛ is greater than 0.004″, 0.008″, or 0.012″ and/or less than 0.04″, or 0.10″. The thickness of the portion of the sealing member 28 in contact with the lower region 20 of the cover member is labeled Tₛ in FIG. 2F. A suitable thickness for T_{M} is greater than 0.005″, 0.010″, or 0.020″ and/or less than 0.04″, or 0.10″. In some instances, the sealing member 28 is constructed of a single, continuous layer of material. Accordingly, the portion of the sealing member 28 that includes the surface(s) interfaced with the housing 14 can be a single, continuous layer of electrically insulating material. Suitable electrically insulating materials include, but are not limited to, Ethylene TetraFluoroEthylene (ETFE), Fluorinated Ethylene Propylene (FEP) and plastics and/or polymers such as polyethylene (PE), Polypropylene (PP), PolyEther Ether Ketone (PEEK). In some instances, the material for the portion of the sealing member 28 that includes the surface(s) interfaced with the housing 14 is the same as the material of the engagement portion of the housing 14. In some instances, the material for the portion of the sealing member 28 that includes the surface(s) interfaced with the housing 14 are different from the material for the engagement portion of the housing 14.

The housing 14 and the sealing member 28 are bonded so as to form a reservoir in which the electrode assembly 12 and the electrolyte are positioned. Suitable mechanisms for bonding the housing 14 and sealing member 28 include, but are not limited to, one or more mechanisms selected from the group consisting of gluing, epoxying, adhering, press fitting, interference fitting, heat sealing and welding such as ultra-sonic welding and laser welding. Accordingly, the interface 36 can include one or more bonding mechanisms selected from a group consisting of an adhesive, a glue, an epoxy, a press fit, interference fit, heat seal, compression fit, and a weld.

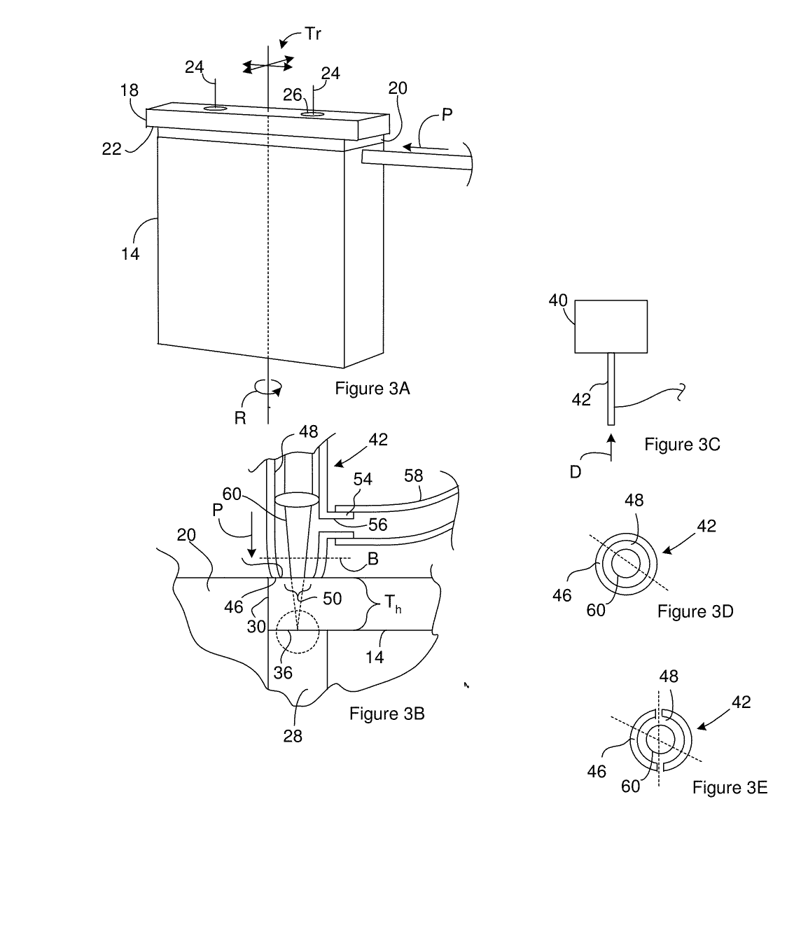

Laser welding of the housing 14 and the sealing member 28 in any of the precursors illustrated in FIG. 1A through FIG. 2G can be performed using a weld system illustrated in FIG. 3A through FIG. 3D. FIG. 3A is a perspective view of the weld system. The weld system includes the battery precursor, a laser source 40, and a weld tool 42. FIG. 3B is a cross section of the weld system at the interface 36 of the battery precursor and the weld tool 42. FIG. 3C is a schematic illustration of the laser source 40 and the weld tool 42. FIG. 3D is a sideview of the laser tool shown in FIG. 3C taken looking in the direction of the arrow labeled D in FIG. 3C.

The weld tool 42 receives a laser signal from the laser source 40. The weld tool 42 can be an instrument such as a rod, bar, stick, or tube. The weld tool 42 includes a pressure surface 46 that contacts the material(s) being welded during the welding process. For instance, FIG. 3A and FIG. 3B illustrate the pressure surface 46 contacting the housing 14 during the welding process. The laser tool includes a laser lumen 48 through which the laser signal is transmitted. The laser lumen 48 terminates at an opening 50 adjacent to the pressure surface 46.

The laser signal can be transmitted from the weld tool without contacting the pressure surface 46. In some instances, the pressure surface 46 surrounds the opening 50 and the laser signal as shown in FIG. 3C; however, the pressure surface 46 need not surround the opening 50 and the laser signal. For instance, the pressure surface 46 can include multiple different regions that do not directly contact one another as shown in FIG. 3E. As is evident from FIG. 3D and FIG. 3E, the pressure surface 46 can be constructed such that a line can be drawn through the laser signal and also through different portions of the pressure surface. As is evident from FIG. 3E, the pressure surface 46 can be constructed such that a line can be drawn through the laser signal and also through different portions of the pressure surface and a second line can be a line can be drawn through the laser signal without contacting the pressure surface. In some instances, the pressure surface 46 is constructed such that a line can be drawn through the laser signal and also through only one portion of the pressure surface. In some instances, the pressure surface 46 can be constructed such that a line can be drawn through the laser signal and also through different portions of the pressure surface and a second line can be drawn through the laser signal and also through only one portion of the pressure surface.

The weld tool includes a pressure material that includes the pressure surface. The pressure material can be the same as the material in the remainder of the instrument or can be different from other materials included in the instrument. Suitable materials for the pressure surface include, but are not limited to, metals, ceramics, and plastics.

The laser signal is transmitted through the lumen and exits the lumen through the opening 50. The pressure surface 46 is configured such that when the pressure surface 46 contacts a material to be welded, the laser signal is incident on the material to be welded. For instance, in FIG. 3B the laser signal is incident on the engagement portion of housing 14 while the pressure surface 46 contacts the engagement portion of the housing 14.

The weld tool 42 can include a lens 52 positioned in the lumen. The lens 52 can be configured such that when the pressure surface contacts the housing 14, the focal point of the laser signal is positioned at the interface 36 of the housing 14 and the sealing member 28.

The weld tool 42 can optionally include a port 54 with a gas lumen 56 in fluid communication with the laser lumen 48. The port 54 can be connected to a conduit 58 to a gas source (not shown). Accordingly, the gas can be transported into the laser lumen 48. During welding, the gas can flow out of the laser lumen 48 through the opening 50 in the weld tool 42. Accordingly, the gas can contact the material being welded. In some instances, the gas fully or partially removes from the vicinity of the weld other gases that might be harmful to the weld joint. Suitable gasses include, but are not limited to, inert gasses such as argon and nitrogen.

The laser weld is performed while applying pressure to the interface 36 between the housing 14 and sealing member 28 as illustrated by the arrow labeled P in FIG. 3A and FIG. 3B. FIG. 3A and FIG. 3B illustrates the pressure being applied to the interface 36 by applying a force to the weld tool 42 so as to drive the pressure surface of the weld tool 42 against at least the engagement portion of the housing 14. However, the force can be applied to the weld tool 42 and/or the battery precursor so as to create the desired pressure at the interface 36. Suitable pressures for application during the laser weld include, but are not limited to, pressures greater than 0.1 lb, 1 lb, 5 lb, or 10 lb and/or less than 80 lb or 800 lb.

In order to form the weld over the desired length, the battery precursor and the weld tool 42 are moved relative to one another. For instance, the battery precursor can be rotated relative to the weld tool 42 as illustrated by the arrow labeled R in FIG. 3A. The rotation movement can be accompanied by translation movements illustrated by the arrows labeled TR in FIG. 3A. The rotation and translation can be combined such that the pressure on the interface 36 is maintained during the rotation of the battery precursor. The movement of the battery precursor can be provided by electronics controlled mechanics on a welding bench. A holder (not shown) can hold the battery precursor while the electronics operate motors such as servo motors and/or stepper motors move the holder so as to provide battery precursor with the desired movements while applying the desired pressure levels. Although the movement of the battery precursor relative to the weld tool 42 is described in the context of a moving battery precursor and a stationary weld tool 42, the weld tool 42 can be moved relative to the battery precursor or movement of the weld tool 42 and the battery precursor can be combined.

In some instances, the movement of the battery precursor relative to the weld tool 42 is performed so as to form a weld that surrounds the sealing member 28. The weld forms a sealed reservoir that is defined by the interior of the housing 14 and the bottom of the sealing member 28. Further, as noted above, the sealing member 28 can be constructed such that electrolyte in contact with the sealing member 28 does not contact the cover member through the sealing member 28. Accordingly, electrolyte within the reservoir is isolated from the cover member.

During laser welding, the housing 14 and sealing member 28 absorb energy from the laser signal 60. The absorbed energy melts the housing 14 and sealing member 28 at the interface 36. However, different insulating materials absorb a light signal at different rates. For instance, a transparent insulating material may not absorb enough laser signal to melt the housing 14 and sealing member 28. In contrast, an opaque material may absorb the laser signal before the energy can reach the interface 36 of the housing 14 and sealing member 28. The inventors have found that the rate of absorption of the laser signal in different insulating material can be a function of wavelength. As a result, the laser signal is matched to the electrically insulating materials such that the level of absorption in the proximity of the interface 36 is sufficient to melt the housing 14 and sealing member 28 at the interface 36. For instance, when the sealing member 28 is Ethylene tetrafluoroethylene (ETFE) and the engagement portion of the housing 14 is Ethylene tetrafluoroethylene (ETFE) with a thickness (Tₕ) of 0.005″, the laser source 40 can be a 355 nm UV laser. As another example, when the sealing member 28 is PE and the engagement portion of the housing 14 is PE with a thickness (Tₕ) of 0.008″, the laser source 40 can be a 2 μm wavelength thulium fiber laser. Suitable wavelengths for the laser signal and most electrically insulating materials that are suitable for use as the housing 14 when the engagement portion of the housing 14 is has a thickness (Tₕ) from 0.001″ to 0.012″ include, but are not limited to, wavelengths greater than 350 nm and/or less than 2.2 μm. During welding, the laser source 40 can be operated as a continuous wave source or as a pulsed laser source 40 such as a Q-switched pulsed laser source 40. Accordingly, the laser signal can be a continuous wave or a pulsed signal.

The battery components can include one or more light absorbing materials that absorb the laser signal. The one or more light absorbing materials are positioned such that absorption of the laser signal increases the temperature of the interface. For instance, the sealing member can include a light absorbing material. As an example, a light absorbing dye can be added to the resin from which the above sealing members are fabricated. As a result, the sealing member can be constructed from the materials disclosed above (plastics and/or polymers such as ETFE, FEP, PE, PP, and PEEK) but with one or more one or more light absorbing materials added to the resin. When the sealing member includes a light absorbing material, the concentration of the light absorbing material in the sealing member can be greater than 0.01%, 0.1%, or 1% and/or less than 2%, 5%, or 10%.

Rather than being included in the sealing member, the one or more light absorbing materials can be included in a component that is added to the sealing member between formation of the sealing member and placement of the housing on the sealing member. For instance, a coating can be added to at least the lateral side of the sealing member that engages the housing 14. As a result, the coating will be present in the interface 36. The coating can include, consist of, or consist essentially of the one or more light absorbing materials. An example of a method for applying the coating to the sealing member includes, but is not limited to, applying a liquid or gel that include, consist of, or consist essentially of the one or more light absorbing materials with a brush, roller or other application mechanism. Suitable liquids include, but are not limited to, paints, dyes, slurries, and pastes.

The housing 14 can include the one or more light absorbing materials or exclude the one or more light absorbing materials. When the housing 14 excludes the one or more light absorbing materials, the housing 14 retains its level of absorption of the light signal ad the laser signal is able to get to the interface before encountering the one or more light absorbing materials. As a result, the positioning of the one or more light absorbing materials in or on the sealing member allows the heat to be generated at or in the interface. Accordingly, in some instances, the housing and the sealing member are constructed of the same material but with the sealing member including the one or more light absorbing materials and the housing or the engagement portion of the housing 14 excluding the one or more light absorbing materials.

The one or more light absorbing materials can each absorb the laser signal at a higher rate than the sealing member would absorb the laser signal if the sealing member did not have the one or more light absorbing materials. For instance, the one or more light absorbing materials can each be less transparent to the laser signal than the sealing medium would be if the sealing member did not have the one or more light absorbing materials. In some instances, the absorbance of sealing member including the one or more light absorbing materials is more than 1.1, 2, or 10 times the absorbance of the sealing member without the one or more light absorbing materials. In some instances, the absorbance of at least one of the one or more light absorbing materials is more than 2, 5, or 10 times the absorbance of the sealing member without the one or more light absorbing materials. An example of a light absorbing materials includes, but is not limited to, near infrared dyes. An example of a light absorbing material suitable for use with a 1 μm wavelength diode laser or fiber laser as the laser source, a housing constructed of ETFE and a sealing member constructed of ETFE is Epolight 3832 from Epolin in Newark N.J.

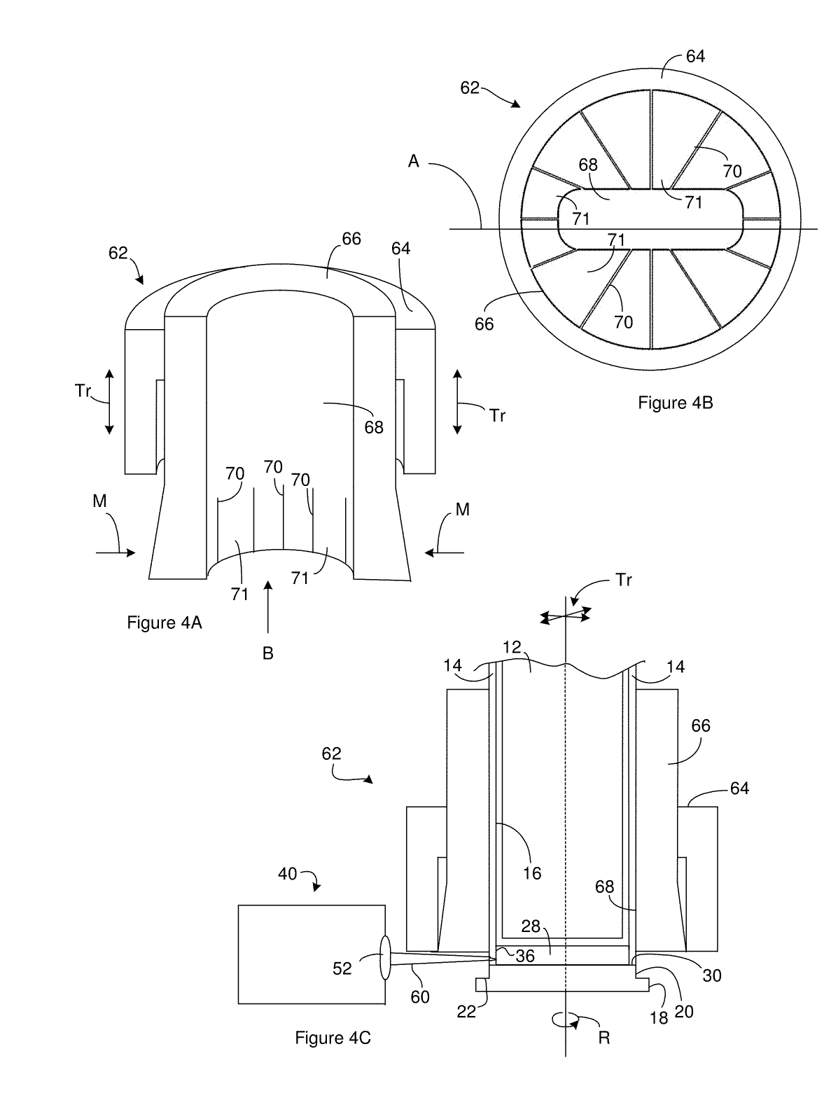

In the weld system illustrated in FIG. 3A through FIG. 3D, the pressure application is coupled to the application of the laser signal through the weld tool 42. However, the mechanism for pressure application can be independent of the laser signal. For instance, the weld system can include a chuck 62 that holds the battery precursor and applies the desired pressure level along the location where the weld is desired. As an example, FIG. 4A through FIG. 4C illustrate an example of a weld system where a chuck 62 for holding the battery precursor is independent of the mechanism for applying a laser signal. FIG. 4A is a perspective view of a cross section of a chuck 62. FIG. 4B is a sideview of the chuck 62 shown in FIG. 4A taken looking in the direction of the arrow labeled B in FIG. 4A. The cross section of FIG. 4A is taken along the line labeled A in FIG. 4B. FIG. 4C illustrates a weld system where a laser source 40 applies a laser signal 60 to a battery precursor held by the chuck 62 of FIG. 4A and FIG. 4B. In FIG. 4C, a cross section of the battery precursor and chuck 62 are shown.

The chuck 62 illustrated in FIG. 4A through FIG. 4C can be a collet. The collet includes a locking collar 64 on a holding collar 66. In some instances, the locking collar 64 surrounds the holding collar 66. The holding collar has an opening 68 sized to receive at least a portion of the battery precursor. Channels 70 or kerfs extend through the holding collar from an end of the holding collar. The channels define gripping members 71 on the holding collar.

The locking collar is configured to be moved toward and/or away from the entrance to the opening on the holding collar as illustrated by the arrows labeled Tr in FIG. 4B. At least a portion of the outer surface of the holding collar tapers outwards. An interior surface of the locking collar is configured such that moving the locking collar toward the entrance of the opening in the holding collar causes the interior of the locking collar to drive the gripping members toward the interior of the opening in the holding collar. When the battery precursor is received in the opening, the movement of the gripping members toward the interior of the opening causes the chuck 62 to grip the battery precursor with the desired pressure level applied to the battery precursor. The movement of the gripping members toward the interior of the opening can close the width of the channels between adjacent gripping members. Accordingly, the pressure applied to the interface 36 by the chuck 62 can surround the battery precursor or substantially surround the battery precursor.

The battery precursor can be removed from the chuck 62 by moving the locking collar away from the entrance to the opening. This movement allows the gripping members to move away from the battery precursor so the battery precursor can be extracted from the opening.

The movement of the gripping members toward the entrance of the opening can reduce the width of the channels. Accordingly, the pressure applied to the battery precursor by the chuck 62 can surround the sealing member 28 or substantially surround the sealing member 28. As a result, the chuck can be configured to apply a pressure of greater than 0.1 lb or 1 lb to at least a portion of the interface. In some instances, the chuck is configured to apply a pressure of greater than 5 lb or 10 lb to a portion of the interface that surrounds the sealing member.

As is evident from FIG. 4C, the battery precursor can be placed in the opening such that a portion of the interface 36 between the housing 14 and the sealing member 28 is located at the entrance to the opening. Accordingly, the pressure applied by the chuck 62 can be applied to the interface 36 between the housing 14 and the sealing member 28. As is shown in FIG. 4C, a portion of the interface 36 between the housing 14 and the sealing member 28 can be located outside of the chuck 62. A laser signal from the laser source 40 can then be incident on the engagement portion of housing 14 in order to form the laser weld in the interface 36.

As is evident from FIG. 4C the chuck applies the pressure to a region of the interface 36 that is adjacent to the region of the interface that receives the laser signal. Accordingly, the pressure applied by the chuck may be above the pressure that is needed to provide the weld in order to create the desired pressure level at the location of the weld. Suitable pressures for application by the chuck during the laser weld include, but are not limited to, pressures greater than 0.1 lb, 1 lb, or 5 lb and/or less than 50 lb or 80 lb.

Although FIG. 4C illustrates the chuck applying pressure to a region of the interface 36 that is adjacent to the region of the interface that receives the laser signal, the laser signal can be angled such that the region of the interface receiving the laser signal overlaps with the region of the interface to which the chuck directly applies the pressure. For instance, the laser signal in FIG. 4C can be angled upwards such that the laser signal is incident on a portion of the interface 36 located under the chuck. In these instance, suitable pressures for application during the laser weld include, but are not limited to, pressures greater than 0.1 lb, 1 lb, or 5 lb and/or less than 50 lb or 80 lb.

FIG. 4C illustrates an optional lens 52 as being included in the laser source 40. The lens 52 can be configured such that during welding, the focal point of the laser signal is positioned at the interface 36 of the housing 14 and the sealing member 28. Although the lens 52 is illustrated as being included in the laser source 40, the lens 52 can be a separate component from the laser source 40 positioned along the path of the laser signal.

In order to form the weld over the desired length, the battery precursor and the light source can be moved relative to one another. For instance, the battery precursor can be rotated relative to the light source as illustrated by the arrow labeled R in FIG. 4C. Because the pressure is applied by the chuck 62 rather than a weld tool 42, in some instances, it may not be necessary to translate the battery precursor relative to the light source. However, when it is desirable to keep the focal point of the laser signal at the same location relative to the interface 36, the rotation movement can be accompanied by translation movements illustrated by the arrows labeled TR in FIG. 4C. The rotation and translation can be combined such that the focal point of the laser signal is maintained at the same location or substantially the same location relative to the interface during the rotation of the battery precursor. The movement of the battery precursor can be provided by electronics controlled mechanics on a welding bench. The electronics can operate motors such as servo motors and/or stepper motors to provide the desired movements. The movement of the battery precursor can be a result of movement of the chuck 62. Although the movement of the battery precursor relative to the weld tool 42 is described in the context of a moving battery precursor and a stationary weld tool 42, the weld tool 42 can be moved relative to the battery precursor or movement of the weld tool 42 and the battery precursor can be combined.

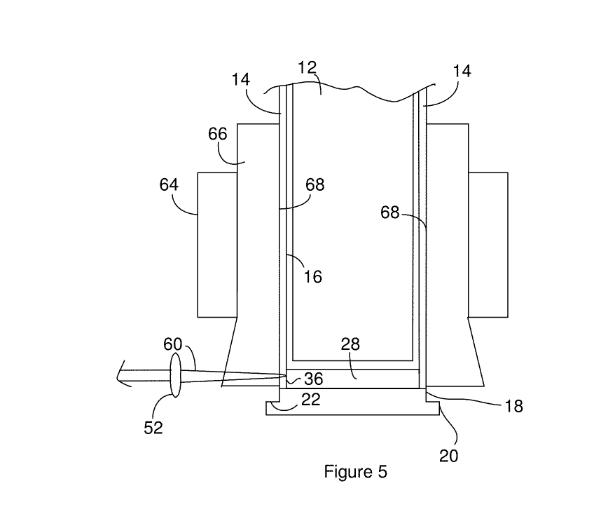

In the weld system of FIG. 4C, the laser signal is not incident on the chuck 62. However, the chuck 62 can be constructed of a material that is transparent or substantially transparent to the laser signal. In these instances, the laser signal can be transmitted through the chuck 62 as shown in FIG. 5. In this configuration, the laser signal can be incident on a portion of the housing 14 that is held by the chuck 62. Accordingly, the laser signal can be incident on a portion of the housing 14 to which the chuck 62 is applying the desired pressure level. In this embodiment, suitable pressures for application during the laser weld include, but are not limited to, pressures greater than 0.1 lb, 1 lb, or 5 lb and/or less than 50 lb or 80 lb.

The above laser welding can be performed under weld purge conditions. A suitable atmosphere for the weld purge conditions includes, but is not limited to, argon and nitrogen.

After forming the weld, an electrolyte can be added to the resulting reservoir. The electrolyte can be added by a number of different methods. For instance, the housing 14 can include a spout (not shown) through which the electrolyte is vacuum filled. After addition of the electrolyte, the spout can be closed off by heat seal and any extra length of the spout can be trimmed.

Although the laser welding is disclosed using drawings that show an interface 36 constructed according to FIG. 1A through FIG. 1F, the disclosed laser welding methods, systems and devices can also be used with the interface 36 constructed as disclosed in the context of FIG. 2A through FIG. 2G.

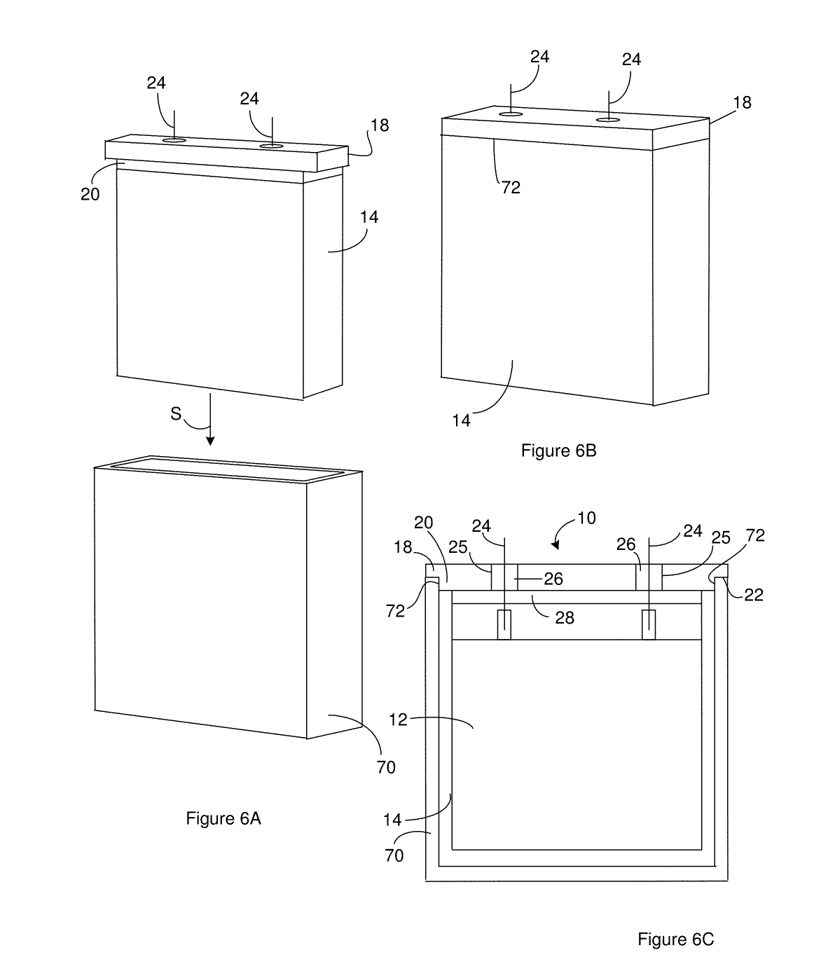

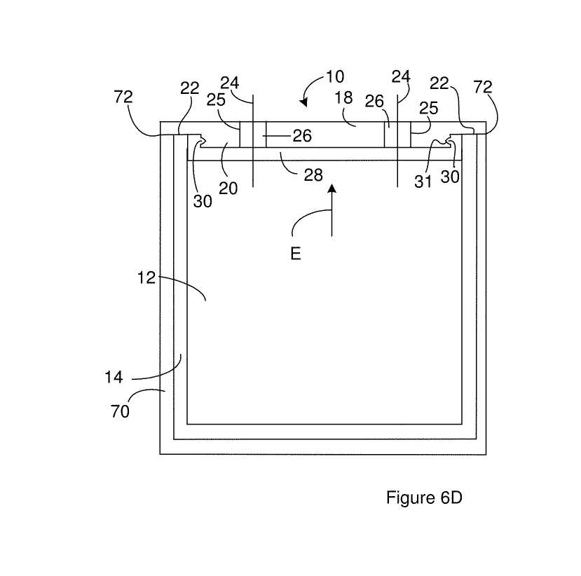

FIG. 6A through FIG. 6C illustrate assembly of a battery from a battery precursor constructed according to FIG. 1A through FIG. 1F. FIG. 6A is an exploded view of the battery. FIG. 6B is a perspective view of the battery. FIG. 6C is a cross section of the battery taken through the feedthrough pins 24. As illustrated by the arrow labeled S in FIG. 6A, the battery precursor is slid into an opening 69 in a battery case 70 that includes walls extending from a bottom. The insertion of the battery precursor into the case can continue until the engagement shelf 22 of the cover member contacts the upper edge of the case. An interface 72 is formed where the case contacts the cover member. The interface 72 can surround the cover member. For instance, at least a portion of the interface 72 can surround the lower region 20 of the cover member. The interface between the case and the cover member can be sealed to provide the battery of FIG. 6B.

Although the battery of FIG. 6A through FIG. 6C is illustrated using the battery precursor of FIG. 1A through FIG. 1F, the battery can be constructed with the battery precursor of FIG. 2A through FIG. 2G. For instance, FIG. 6D is a cross section of a battery constructed according to FIG. 6A through FIG. 6C but with the battery precursor of FIG. 2A through FIG. 2G.

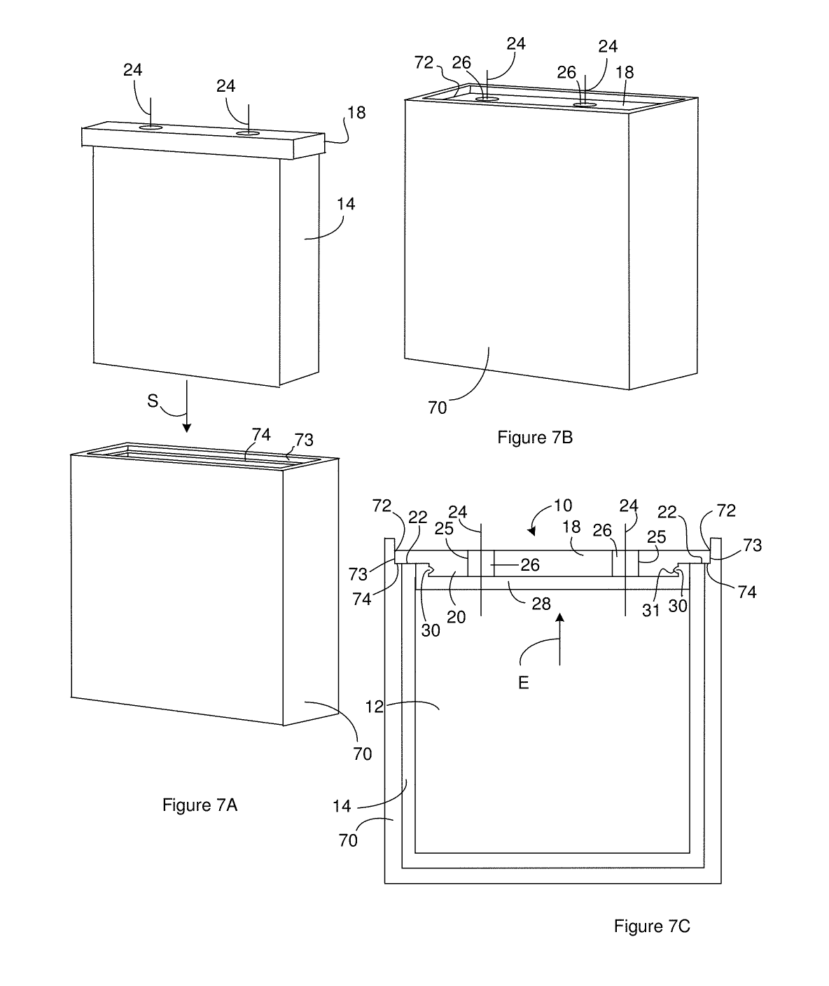

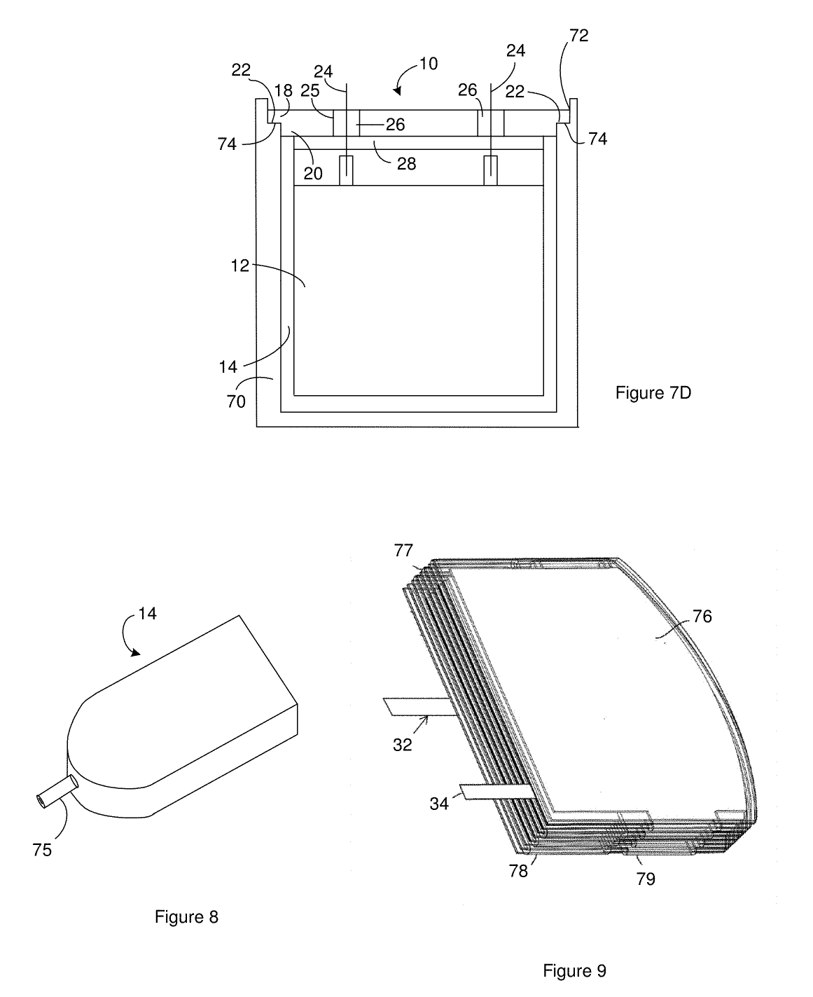

FIG. 7A through FIG. 7C illustrate assembly of a battery from a battery precursor constructed according to FIG. 2A through FIG. 2G. FIG. 7A is an exploded view of the battery. FIG. 7B is a perspective view of the battery. FIG. 7C is a cross section of the battery taken through the feedthrough pins 24. As illustrated by the arrow labeled S in FIG. 7A, the battery precursor is slid into an opening 69 in a battery case 70 that includes walls extending from a bottom. A notch 73 extends into a wall of the case so as to define a seat 74 on the wall. As is evident from FIG. 7C, the notch 73 can extend from the upper edge of the case 70 to the seat 74. In some instances, the thickness of the walls of the notch 73 may be 0.001 to 0.030inches and the thickness of the portions of the walls that exclude the notch 73 can be 0.002 to 0.031 inches.

As shown in FIG. 7C, the seat 74 and at least a portion of the notch 73 may be complementary to the engagement shelf 22 and the lateral sides of the upper region 18 of the cover member. As a result, the battery precursor can be inserted into the case 70 until the engagement shelf 22 of the cover member contacts the seat 74. An interface 72 is formed where the case 70 contacts the cover member. Since the seat 74 can surround the interior of the case, the interface 72 can surround the cover member. For instance, the interface 72 can surround the upper region 18 of the cover member. The interface between the case 70 and the cover member can be sealed to provide the battery of FIG. 7B. Suitable methods for sealing the interface 72 include, but are not limited to, welding such as laser welding. Suitable materials for the case include, but are not limited to, titanium, stainless steel, and aluminum.

Although the battery of FIG. 7A through FIG. 7C is illustrated using the battery precursor of FIG. 2A through FIG. 2G, the battery can be constructed with the battery precursor of FIG. 1A through FIG. 1F. For instance, FIG. 7D is a cross section of a battery constructed according to FIG. 7A through FIG. 7C but with the battery precursor of FIG. 1A through FIG. 1F.

Suitable materials for the case 70 include, but are not limited to, titanium, stainless steel, and aluminum. One or more mechanisms can be used to seal the interface 72 where the case 70 contacts the cover member in the batteries of FIG. 6A through FIG. 7D. The one or more mechanisms can be selected from the group consisting of gluing, epoxying, adhering, press fitting, interference fitting, heat sealing and welding such as ultra-sonic welding, resistance welding and laser welding. Accordingly, the interface 72 can include one or more bonding mechanisms selected from a group consisting of an adhesive, a glue, an epoxy, a press fit, interference fit, compression fit, heat seal, and a weld. In instances, where an interference fit and/or press fit are used, the fit can cause outward flexing of the case 70. In some instances, the one or more sealing mechanisms can be selected so as to provide a hermetic seal at the interface 72 where the case 70 contacts the cover member.

In the batteries and battery precursors illustrated above, the sealing member 28 can contact the feedthrough pins 24 and be sealed to the feedthrough pins 24. As a result, electrolyte in contact with the sealing member 28 does not contact the cover member through the sealing member 28. As a result, the sealing member 28, and housing 14 can form a sealed container that includes the reservoir in which the electrode assembly 12 and electrolyte is positioned. In some instances, the sealing member 28 is constructed such that electrolyte in contact with the sealing member 28 contacts the sealing medium 26 without contacting the cover member through the sealing member 28. For instance, the sealing member 28 can be spaced apart from the feedthrough pins 24 such that the electrolyte can contact the sealing medium 26 through the space between the sealing member 28 and the feedthrough pins 24. As a result, the sealing member 28, one or more sealing media 26, and housing 14 can form a sealed container that includes the reservoir in which the electrode assembly 12 and electrolyte is positioned. In some instances, the sealing member is immobilized on the cover member in that the portion of the sealing member contacting the cover member is not free to move away from the cover member. Suitable methods for attaching the sealing member 28 to the cover assembly include, but are not limited to, overmolding, injection molding, and vacuum forming.

In the batteries illustrated above, the case 70 and the cover member form a battery case. In some instances, the case 70 and the cover member battery case are constructed of electrically conducting materials. Additionally, the case 70 can be in electrical communication with the cover member. However, because the container is sealed, the electrolyte within the container does not contact the battery case. For instance, a liquid electrolyte within the container cannot flow out of the container into contact with the battery case. Accordingly, the electrolyte is not located outside of the container. Additionally, since the container is constructed of electrically insulating materials, the battery case is not in electrical communication with either the electrolyte or with the electrodes in the electrode assembly. Accordingly, the battery can be a case-neutral battery where the battery case, the cover member, and/or case 70 are electrically conducting.

In the batteries above, in some instances, the battery case serves as the exterior of the battery in that the battery case contacts the atmosphere in which the battery is positioned. For instance, the case 70 and cover member can contact the atmosphere in which the battery is positioned.

As is most evident in FIG. 6C, FIG. 6D, FIG. 7C, and FIG. 7D, the housing 14 can be in direct physical contact with the case 70. Alternately, the housing 14 can be spaced apart from the case 70. In some instances, one or more regions of the housing 14 are in direct physical contact with the case 70 and one or more regions of the housing 14 are spaced apart from the case 70.

FIG. 8 is a perspective view of one example of a suitable housing 14. The housing has a spout 75 extending from a wall of the housing 14. A lumen extends through the spout 75 into the interior of the housing 14. During fabrication of the battery, the spout can be used to place electrolyte in the interior of the housing 14. For instance, electrolyte can be injected and/or vacuum filled into the interior of the housing 14 through the spout. After placement of the electrolyte can be injected into the interior of the housing 14, the spout 75 can be removed. After removal of the spout 75, an aperture will remain through the wall or bottom of the housing 14. The aperture can be sealed in order to seal the interior of the housing 14. Suitable methods for sealing the aperture include, but are not limited to, heat sealing, ultrasonic welding, and laser welding. The spout can be constructed of the same material as the housing 14. Accordingly, the spout can be continuous with the housing.

FIG. 9 is a perspective view of an example of a suitable electrode assembly 12. The illustrated electrode assembly 12 has a stacked cell format, such as described in U.S. patent application Ser. No. 15/152,166, granted US Patent publication number 2016/0254516, and incorporated herein in its entirety. The electrode assembly 12 include anodes 76 alternated with cathodes 77. The cathodes 77 can be electrically interconnected by cathode bridges 78. Similarly, the anodes 76 can be electrically interconnected by anode bridges 79. In addition, the first conductor 32 can be connected to one of the cathodes 77 and the second conductor 34 can be connected to one of the anodes 76.

Heat sealing is an alternative to the laser welding disclosed above. Accordingly, the battery assembly method disclosed above can be performed with heat sealing substituted for laser welding and/or a heat-sealing system substituted for the above weld system.

An example of a heat sealing mechanism employs conduction to transfer thermal energy from one or more heating elements through the sealing member and/or the housing to the interface between the sealing member and the engagement portion of the housing. The one or more heating elements are configured to deliver enough thermal energy to the interface to melt at least the portions of the sealing member and housing that are located at the interface, that define the interface, and/or that contact one another at the interface. Accordingly, a heat-sealing system can include one or more heating elements that have a temperature above the melting point of one or more elements included in the interface of the interface between the sealing member and the engagement portion of the housing. For instance, the one or more heating elements can have a temperature above the melting point of the sealing member and/or of the engagement portion of the housing.

In some instance, the one or more heating elements include one or more contact surfaces that contact the sealing member and/or the housing during the heat sealing process. The one or more contact surfaces can have a temperature that is more than 0.90, or 1.0 and/or less than 1.1, 1.2, or 2.0 times the melting point of the sealing member and/or of the engagement portion of the housing.

In some instances, the heat-sealing system also applies a pressure to a battery precursor such that a pressure is applied to the interface between the sealing member and the engagement portion of the housing. Suitable pressures for application to the interface during the heat weld include, but are not limited to, pressures greater than 0.1 lb, 1 lb, 5 lb, or 10 lb and/or less than 80 lb or 800 lb.

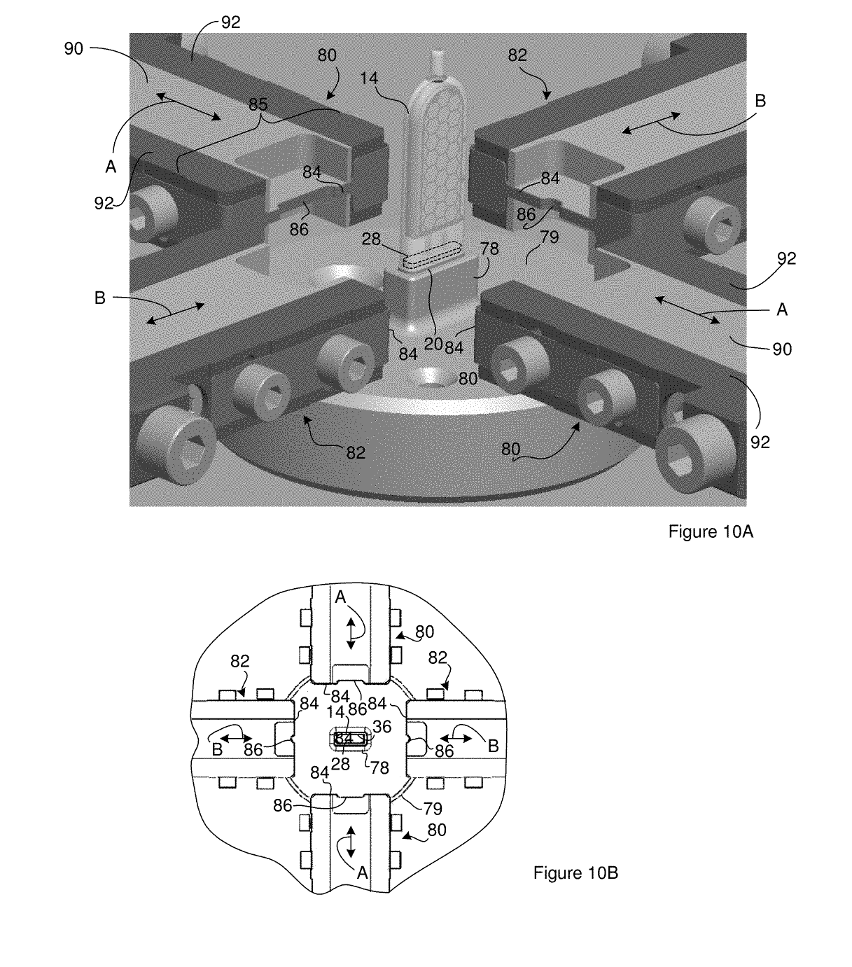

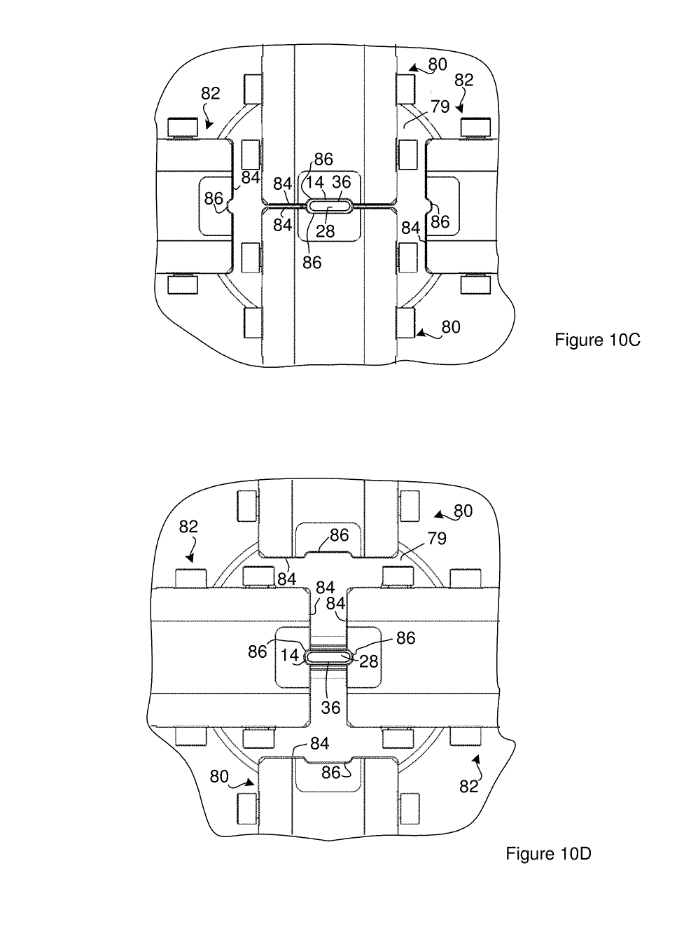

FIG. 10A through FIG. 10D illustrate a heat-sealing system suitable for creating a heat seal at the interface 36 between the sealing member 28 and the engagement portion of the housing 14. FIG. 10A is a perspective view of the heat-sealing system. FIG. 10B is a topview of a cross-section of the heat-sealing system of FIG. 10A. The heat-sealing system includes a battery precursor between heating elements. The battery precursor can be constructed as disclosed in the context of FIG. 1A through FIG. 1F or as disclosed in the context of FIG. 2A through FIG. 2G. FIG. 10C is a topview of a cross-section of the heat-sealing system of FIG. 10B after a first portion of the heating elements have been moved into contact with the battery precursor. FIG. 10D is a topview of a cross-section of the heat-sealing system of FIG. 10C after a second portion of the heating elements have been moved into contact with the battery precursor.

The heat-sealing system includes a holder 78 that holds a battery precursor such as the battery precursor of FIG. 1D or FIG. 2E. The holder 78 is configured such that the battery precursor can be removed from the holder 78. For instance, the holder 78 can hold the battery precursor using a mechanism such as a press fit, a clamp, a nest, and a pocket. In some instances, the holder 78 is optionally positioned on a platform 79.

The holder 78 is configured to the battery precursor such that at least a portion of the interface 36 between the sealing member 28 and the engagement portion of the housing 14 is not covered by the holder 78. For instance, the location of the sealing member 28 under the housing 14 is shown by dashed lines in FIG. 10A. The cross section of FIG. 10B through FIG. 10C is taken through the interface 36 between the sealing member 28 and the engagement portion of the housing 14. As a result, FIG. 10B through FIG. 10C illustrate the engagement portion of the housing 14 surrounding the sealing member 28 as discussed above. However, because FIG. 10B through FIG. 10C are topviews of the cross section, features of the system that are below the plane of the cross section are shown. For instance, the holder 78 is evident in FIG. 10B through FIG. 10C illustrate the holder 78 even through the holder 78 is below the cross section through the interface 36.

The holder 78 is positioned between actuators that each includes one or more heating elements 84 that each have one or more contact surfaces 86. For instance, the holder of FIG. 10A and FIG. 10B is positioned between first actuators 80. The first actuators 80 are configured to be moved toward and away from the battery precursor as illustrated by the arrows labeled A in FIG. 10A and FIG. 10B. The battery precursor is also positioned such that the battery precursor is positioned between second actuators 82. The second actuators 82 are configured to be moved toward and away from the battery precursor as illustrated by the arrows labeled A in FIG. 10A and FIG. 10B.

The first actuators 80 and the second actuators 82 each includes one or more heating elements 84 on a support 85. The illustrated heating elements 84 each includes a contact surface 86 configured to contact the battery precursor. At least a portion of the contact surfaces 86 are contoured. For instance, the contact surfaces 86 can each include or consist of one or more flat regions and/or one or more curved regions.

As noted above, the heating elements 84 can be heated such that the temperature of the contact surfaces 86 is more than 0.90, or 1.0 and/or less than 1.1, 1.2, or 2.0 times the melting point of the sealing member and/or of the engagement portion of the housing 14. In some instances, the heating elements 84 can be heated such that the temperature of the contact surfaces 86 is more than 120° C., 225° C., or 250° C. and/or less than 150° C., 250° C., or 300° C. during the heat sealing of the interface 36. Suitable heating elements 84 include, but are not limited to, resistive heating elements 84, inductive heating elements, and friction heating elements. When an electrical current passes through the heating elements as occurs with resistive heating elements, the supports can each be a bar that includes an electrical insulator 90 between electrical conductors 92. In some instances, the electrical insulators 90 and electrical conductors 92 each have a bar configuration or the electrical conductors are each a metal layer, metal coating, or metal member on the electrical insulators 90. In instances where the heating elements 84 conduct electrical current, the heating elements 84 can be attached to the support such that heating elements 84 are in electrical communication with the electrical conductors 92. Accordingly, the electronics can apply a potential difference across the electrical conductors 92 to provide an electrical current through the heating elements 84.

Electronics (not shown) can be configured to operate the heat-sealing system. For instance, the electronics can be configured to control the position of the first actuators 80 and the second actuators 82 and/or the temperature of the contact surface 86. In some instances, the electronics determine or estimate temperature of one or contact surfaces 86 based on a voltage drop across the heating element including the heating element that includes the contact surface. Additionally or alternately, the heat-sealing system can include one or more temperature sensors (not shown) positioned so as provide an output that indicates to the electronics a temperature of one or contact surfaces 86. The electronics can use the measured and/or approximated temperature to operate the heating elements 84 such that a target temperature or target temperature range is maintained at all or a portion of the contact surfaces 86. Suitable temperature sensors include, but are not limited to, thermocouples, and Resistance Temperature Detectors (RTDs).

In FIG. 10A and FIG. 10B, the battery precursor can be constructed according to FIG. 1D or FIG. 2E. As a result, the sealing member 28 and the engagement portion of the housing 14 in the battery precursor need not be bonded together at the interface 36 although optional bonding through the use of an adhesive or other bonding mechanism may be employed. The electronics can form a heat seal in the interface 36 by operating the heating elements 84 such that the contact surfaces 86 are at the desired temperatures. When the contact surfaces 86 are at the desired temperatures, the electronics perform a first sealing operation. During the first sealing operation, the electronics operate the first actuators 80 such that the contact surfaces 86 on the first actuators 80 move toward and contact the battery precursor as shown in FIG. 10C. The battery precursor is positioned such thermal energy from the contact surfaces 86 is conducted through the battery precursor to the interface 36. For instance, in FIG. 10C, the contact surfaces 86 each contacts a portion of the housing 14 located over the engagement portion of the housing 14. In particular, the contact surfaces 86 each contacts the housing 14 such that a line can be drawn perpendicular to the interface 36 and through the contact surface 86 and the sealing member 28. Additionally, the battery precursor can be positioned such that at least a portion of the interface 36 is between the contact surfaces 86 on different first actuators 80. For instance, the interface 36 can be between the contact surfaces 86 on the heating elements 84 included on a different first actuator 80. The electronics can operate the first actuators 80 such that the contact surfaces 86 are withdrawn from the battery precursor in response to a first sealing condition being satisfied.

After the first actuators 80 are sufficiently withdrawn, the electronics can perform a second sealing operation. During the second sealing operation, the electronics operate the second actuators 82 such that the contact surfaces 86 on the second actuators 82 move toward and contact the battery precursor as shown in FIG. 10D. The battery precursor is positioned such thermal energy from the contact surfaces 86 is conducted through the battery precursor to the interface 36. For instance, In FIG. 10D, the contact surfaces 86 each contacts a portion of the housing 14 located over the engagement portion of the housing 14. In particular, the contact surfaces 86 each contacts the housing 14 such that a line can be drawn perpendicular to the interface 36 and through the contact surface 86 and the sealing member 28. Additionally, the battery precursor can be positioned such that at least a portion of the interface 36 is between the contact surfaces 86 on different first actuators 80. For instance, the interface 36 can be between the contact surfaces 86 on the heating elements 84 included on a different second actuator 82. The electronics can operate the second actuators 82 such that the contact surfaces 86 are withdrawn from the battery precursor in response to a second sealing condition being satisfied. The battery precursor can be removed from the holder 78 after the second actuators 82 withdraw the contact surfaces 86 from the battery precursor.

The first sealing condition and the second sealing condition are selected such that the materials at the interface 36 melt sufficiently to provide the desired heat seal. For instance, the first sealing condition can be passage of a first sealing time while the contact surfaces 86 on the first actuators 80 contacts the battery precursor. As a result, a first seal portion is formed in response to the contact between contact surfaces 86 on the first actuators 80 and the battery precursor. For instance, the second sealing condition can be passage of a second sealing time while the contact surfaces 86 on the second actuators 82 contact the battery precursor. As a result, a second seal portion is formed in response to the contact between contact surfaces 86 on the second actuators 82 and the battery precursor. In some instances, the times for the first sealing time and/or the second sealing time are greater than 0.1 seconds, 0.4 seconds or 3 and/or less than 5 seconds, or 10 seconds. The materials at the interface 36 can include at least the portions of the sealing member 28 and housing 14 that are located at the interface 36, that define the interface 36, and/or that contact one another at the interface 36.

In some instances, the combination of the first seal portion and the second seal portion are sufficient to form the entire length of the interface 36 heat seal. For instance, the first seal portion seal and the second seal portion can combine to form an interface 36 heat seal that surrounds the sealing member 28. In some instances, the contact surfaces 86 are configured such that different portions of the interface 36 heat seal overlap one another. For instance, the contact surfaces 86 can be configured such that the first seal portion of overlaps the second seal portion. In some instances, this overlap is a result of different contact surfaces 86 contacting the same region of the battery precursor during different sealing operations.

As is evident from FIG. 10C and FIG. 10D, the contact surfaces 86 are contoured to have a shape that is complementary to the shape the battery precursor at the location where the contact surfaces 86 come into contact with the battery precursor. As an example, each of the contact surfaces 86 in FIG. 10A through FIG. 10D includes a recess into which a side of the battery precursor can be received as shown in FIG. 10C and FIG. 10D.

The complementary relationship between the battery precursor and the contact surfaces 86 can be such that the contact surface 86 contacts the battery precursor along the length of the region under which the portion of heat seal is to be formed. Additionally, the complementary relationship can be such that contact surface 86 to applies a constant or substantially constant level of pressure along the contact area between the battery precursor and the contact surface 86. The constant or substantially constant pressure level can help to ensure that a uniform seal forms between the housing 14 and the sealing member 28.

As is evident in FIG. 10C and FIG. 10D, the battery precursor is effectively squeezed between different actuators. As a result, the electronics can operate the actuators such that a pressure is applied to the battery precursor during the sealing operations. The battery can be positioned such that the pressure applied to the battery precursor transfers to the interface 36. For instance, all or a portion of the contact surfaces 86 each can serve as a pressurization surface that the electronics drive against the battery precursor so as to apply the pressure to the battery precursor. When the interface 36 is located between different pressurization surfaces, the pressure applied to the battery precursor results in a pressure being applied to the interface 36. Although all or a portion of the contact surfaces 86 each can serve as a pressurization surface, the heat sealing system can include actuators with one or more other pressurization surfaces that are do not deliver thermal energy to the battery precursor but are still employed to apply pressure to the interface 36.

In the above description, the seal portions formed during the first sealing operation and the second sealing operation form the desired length of the interface 36 heat seal. However, the combination of the first seal portion and the second seal portion can form a portion of the length of the interface 36 heat seal. In these instances, the heat-sealing system can perform one or more additional sealing operations so as to provide the interface 36 heat seal with the desired length. In these instances, the heat-sealing system can include additional heating elements 84 (not shown) for forming one or more additional portions of the interface 36 heat seal. For instance, the heat-sealing system can include third actuators that each includes one or more heating elements 84 with contact surface 86(s).

Alternately, the first actuators 80 can be constructed such that the first sealing operation form the desired length of the interface 36 heat seal. For instance, FIG. 10C illustrates a first sealing operation forming the first seal portion along the face of a battery precursor and a second sealing operation forming the second seal portion along an edge of the battery precursor. However, the contact surfaces 86 can be contoured such that the first sealing operation forms the first seal portion along the face of a battery precursor and also along the second seal portion along an edge of the battery precursor. For instance, the recesses in the contact surfaces 86 can be sized to receive half of the battery precursor.

Although the above heat-sealing system illustrates each of the sealing operations performed with two actuators, the heat-sealing system can be configured such that a sealing operation can be performed with more than two actuators. As a result, the battery precursor can be concurrently contacted by the contact surfaces 86 on three or more actuators. In these instances, a sealing operation that forms the entire length of the interface 36 heat seal is simplified. Accordingly, configuring the heat-sealing system to concurrently contact a battery precursor with the contact surfaces 86 on three or more actuators permits the entire length of the interface 36 heat seal to be formed in one or more sealing operations.

The heat sealing system is disclosed in the context of the contact surfaces 86 contacting the battery precursor. In the above illustrations, the contact surfaces 86 each contacts the housing 14. In particular, the contact surfaces 86 each contacts a portion of the housing 14 located over the engagement portion of the housing 14. For instance, the contact surfaces 86 each contacts the housing 14 such that a line can be drawn perpendicular to the interface 36 and through the contact surface 86 and the sealing member 28. Alternately, the connection between the housing 14 and the sealing member 28 can be constructed such that at least a portion of the contact surfaces 86 each contacts the sealing member 28 at a location that is over the interface 36.

Although the actuators are disclosed as moving the contact surface 86 relative to the holder 78 or to the battery precursor, one or more of the actuators can be immobile relative to the holder 78 or to the battery precursor and/or an actuator can move the holder 78 or the battery precursor relative to an immobile contact surface 86. For instance, when one of the first actuators 80 is immobile relative to the platform 79 or to the battery precursor, one or more of the other first actuators 80 can push the battery precursor against the immobile first actuator 80(s) so as to achieve the desired level of pressure and thermal energy conduction. Additionally or alternately, when an actuator moves the holder 78 or the battery precursor relative to a contact surface 86, the contact surface 86 can be on an immobile support and the actuator can move the holder 78 or the battery precursor such that the battery precursor is pushed against the immobile contact surface 86 so as to create the desired pressure and thermal conduction levels.

Although operation of the heat-sealing system is disclosed in the context of opposing actuators concurrently moving toward the battery precursor and into contact with the battery precursor, the sequence of activator movements can be different. For instance, the second actuators 82 can contact the battery precursor before the first second actuators 82. Additionally or alternately, the actuators can be moved independently. For instance, one of the first actuators 80 can be moved into contact with the battery precursors before another one of the actuators is moved into contact with the battery precursor. Operation of the heat-sealing system is also disclosed in the context of opposing actuators concurrently withdrawing from contact with the battery precursor; however, the sequence of precursor movements can be different. For instance, one of the first actuators 80 can be withdrawn from contact with the battery precursors before a different one of the first actuators 80 is withdrawn from contact with the battery precursor.

After removal of the battery precursor from the holder 78, the method of battery fabrication can be resumed as disclosed above. For instance, the electrolyte can be added to the reservoir that results from the heat seal and the battery fabrication can be resumed as disclosed in the context of FIG. 6A.

Although the heat sealing is disclosed using drawings that show an interface 36 constructed according to FIG. 1A through FIG. 1F, the disclosed heat sealing methods, systems and devices can also be used with the interface 36 constructed as disclosed in the context of FIG. 2A through FIG. 2G.

Although the above FIGS. 1A through FIG. 10D and the associated description describe a method of assembly a battery, the sequence disclosed above can be performed in a different order than the disclosed order. For instance, a header and/or an electrode assembly that includes the sealing member can be obtained by fabrication and/or full or complete purchase from a supplier. The conductors from the electrode assembly 12 can be attached to the feedthrough pins in the header so as to provide electrical communication between the conductors and feedthrough pins. Additionally, the interior of the housing can be filled with electrolyte by supplying the electrolyte through the opening 16 in the housing. After placing the electrolyte in the housing, the battery precursor can be formed by placing the combination of the electrode assembly and the header can be placed in the interior of the housing until the housing shelf 30 engages the upper edge of the housing 14 (FIG. 1E) or until the engagement shelf 22 engages the upper edge of the housing 14 (FIG. 2F). The housing can be sealed to the sealing member as disclosed above. The resulting battery precursor can be placed in the interior of the case until the engagement shelf 22 of the cover member contacts the upper edge of the case 70 (FIG. 6C and/or FIG. 6D) or until the engagement shelf 22 of the cover member contacts the seat 74 (FIG. 7C and/or FIG. 7D).

In another embodiment of a method of fabricating the battery, a header and/or an electrode assembly that includes the sealing member can be obtained by fabrication and/or full or complete purchase from a supplier. The conductors from the electrode assembly 12 can be attached to the feedthrough pins in the header so as to provide electrical communication between the conductors and feedthrough pins. The battery precursor is formed by placing the combination of the electrode assembly and the header can be placed in the interior of the housing until the housing shelf 30 engages the upper edge of the housing 14 (FIG. 1E) or until the engagement shelf 22 engages the upper edge of the housing 14 (FIG. 2F). The housing can be sealed to the sealing member as disclosed above. After sealing the housing to the sealing member, the electrolyte is placed in the interior of the housing. For instance, the electrolyte can placed in the interior of the housing using a spout as disclosed in the context of FIG. 8. The resulting battery precursor can be placed in the interior of the case until the engagement shelf 22 of the cover member contacts the upper edge of the case 70 (FIG. 6C and/or FIG. 6D) or until the engagement shelf 22 of the cover member contacts the seat 74 (FIG. 7C and/or FIG. 7D).

### EXAMPLE 1

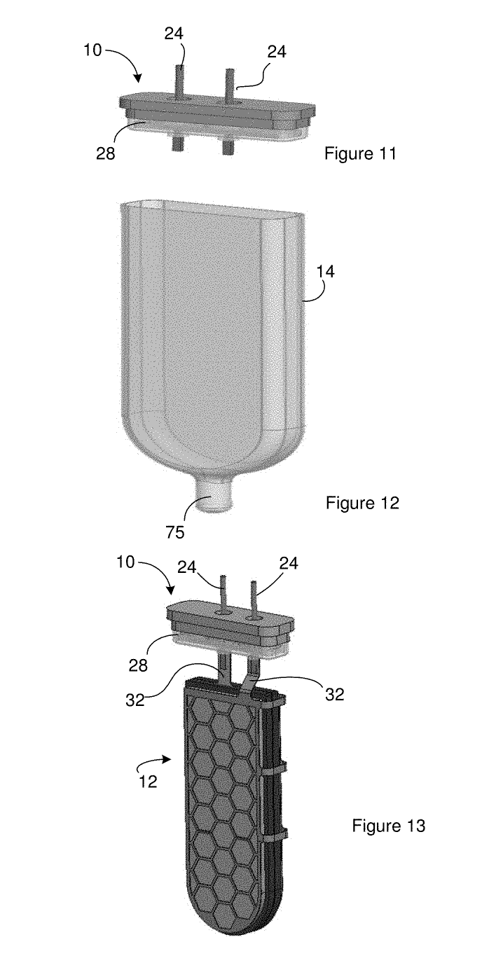

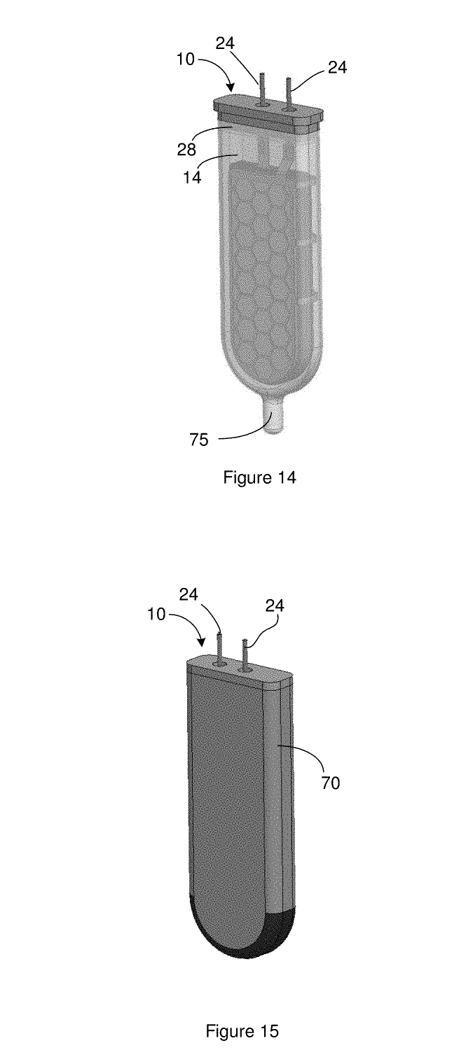

FIG. 11 shows an example of a header that includes a cover member overmolded with a thermoplastic sealing member 28. The sealing member 28 could be polyethylene (PE), Polypropylene (PP), Polyether ether ketone (PEEK), and Ethylene tetrafluoroethylene (ETFE). FIG. 12 shows an example of a suitable housing 14. FIG. 13 shows one example of an electrode assembly 12 that is suitable for use with the housing 14 of FIG. 12 and the header of FIG. 11. The electrode assembly 12 includes conductors 32 connected to feedthrough pins 24 included in the header. FIG. 14 illustrates a battery precursor assembled by sliding the housing 14 of FIG. 12 is over the electrode assembly in FIG. 13. The housing 14 is sealed to the sealing member 28 as disclosed above. An electrolyte can be added to the interior of the housing before or after the electrode assembly is placed in the interior of the housing. FIG. 15 illustrates a battery case 70 is pulled over the housing 14 and attached to the header 10 to provide a completed battery. The finished battery case can have infinite impedance against both feedthrough pins 24 as the electrode assembly and electrolyte are fully isolated from the 70 case and header.

Although the above weld system and/or heat seal systems are disclosed in the context of welding a housing to a sealing component, the disclosed systems, tools and chucks can be employed in the sealing of other battery components.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A battery, comprising:
an electrode assembly in an interior of an electrically insulating container, the electrode assembly including one or more first electrodes alternated with one or more second electrodes; and
the container being positioned in an interior of an electrically conducting battery case, the container being constructed such that the battery case is not in electrical communication with the one or more first electrodes and the one or more second electrodes, and such that an electrolyte positioned in an interior of the container does not contact the battery case.

2. The battery of claim 1, wherein the electrolyte is not located outside of the container.

3. The battery of claim 1, wherein the container includes a sealing member and a housing arranged such that the sealing member seals an opening in the housing.

4. The battery of claim 3, wherein the housing surrounds the electrode assembly.

5. The battery of claim 3, wherein the housing and the sealing member are constructed of the same material.

6. The battery of claim 3, wherein the housing contacts the battery case.

7. The battery of claim 6, wherein the electrode assembly contacts the housing.

8. The battery of claim 3, wherein the cover member is sealed to the housing.

9. The battery of claim 3, wherein the battery case includes a cover member in electrical communication with a case and the sealing member is immobilized on a cover member.

10. The battery of claim 9, wherein the sealing member and the housing are each a thermoplastic.

11. The battery of claim 1, wherein a first terminal that is accessible from an exterior of the battery case is in electrical communication with the one or more first electrodes and a second terminal that is accessible from an exterior of the battery case is in electrical communication with the one or more second electrodes.

12. The battery of claim 11, wherein the first terminal is in electrical communication with a first electrical conductor that extends through the container and the second terminal is in electrical communication with a first electrical conductor that extends through the container.

13. A method of fabricating a battery, comprising:
fabricating an electrically insulating container that includes an electrode assembly in an interior of the container, the electrode assembly including one or more first electrodes alternated with one or more second electrodes; and
fabricating an electrically conducting battery case that includes the container in an interior of the battery case without the one or more first electrodes and the one or more second electrodes being in electrical communication with the battery case.

14. The method of claim 13, wherein the battery case surrounds the electrode assembly.

15. The method of claim 13, further comprising:
positioning an electrolyte in an interior of the container without the electrolyte contacting the battery case after fabricating the battery case.

16. The method of claim 15, wherein the electrolyte is not positioned outside of the container after fabricating the battery case.

17. The method of claim 13, wherein fabricating the battery case includes attaching a cover member to a case.

18. The method of claim 17, wherein the case surrounds the electrode assembly before the cover is attached to the case.

19. The method of claim 13, wherein the container includes a sealing member and a housing arranged such that the sealing member seals an opening in the housing.

20. The method of claim 19, wherein the housing surrounds the electrode assembly.
